(19) United States
(12) Patent Application Publication
(10) Pub. No.: US 2019/0065453 A1
(43) Pub. Date: Feb. 28, 2019

(54) RECONSTRUCTING TEXTUAL ANNOTATIONS ASSOCIATED WITH INFORMATION OBJECTS

(71) Applicant: ABBYY Development LLC, Moscow (RU)

(72) Inventors: Ilya Bulgakov, Moscow (RU); Evgenii Indenbom, Moscow (RU)

(21) Appl. No.: 15/715,799

(22) Filed: Sep. 26, 2017

(30) Foreign Application Priority Data
Aug. 25, 2017 (RU) 2017130191

(51) Int. Cl. G06F 17/24; G06F 17/30

(52) U.S. Cl. CPC G06F 17/241; G06F 17/30684; G06F 17/30401

(57) ABSTRACT

Systems and methods for reconstructing textual annotations associated with information objects. An example method comprises: receiving a natural language text associated with a plurality of information objects, wherein each information object is associated with one or more attributes; identifying an information object of the plurality of information objects, such that at least one attribute of the identified information object is not associated with at least one textual annotation; identifying one or more candidate textual annotations to be associated with the attribute, such that each candidate textual annotation is represented by a fragment of the natural language text referencing the value of the attribute; determining ranking scores of the identified candidate textual annotations; and selecting one or more candidate textual annotations having an optimal ranking score.

REFERENCE TO RELATED APPLICATIONS

The present application claims the benefit of priority under 35 U.S.C. § 119 to Russian Patent Application No. 2017130191 filed Aug. 25, 2017, the disclosure of which is incorporated herein by reference in its entirety for all purposes.

### TECHNICAL FIELD

The present disclosure is generally related to computer systems, and is more specifically related to systems and methods for natural language processing.

### BACKGROUND

Interpreting unstructured or weakly-structured information represented by a natural language text may be hindered by the inherent ambiguity of various natural language constructs. Such ambiguity may be caused, e.g., by polysemy of natural language words and phrases and/or by certain features of natural language mechanisms that are employed for conveying the relationships between words and/or groups of words in a natural language sentence (such as noun cases, order of words, etc).

### SUMMARY OF THE DISCLOSURE

In accordance with one or more aspects of the present disclosure, an example method of adjusting parameters of a classifier function employed for evaluating attributes associated with information objects may comprise: receiving, a natural language text; extracting, from the natural language text, a plurality of information objects, wherein each information object is associated with one or more attributes; verifying values of the attributes of the plurality of information objects; identifying an information object of the plurality of information objects, such that at least one attribute of the identified information object is not associated with at least one textual annotation; and reconstructing the textual annotation associated with the attribute of the identified information object, wherein the textual annotation is represented by a fragment of the natural language text referencing a value of the attribute.

In accordance with one or more aspects of the present disclosure, an example method of reconstructing textual annotations associated with information objects may comprise: receiving a natural language text associated with a plurality of information objects, wherein each information object is associated with one or more attributes; identifying an information object of the plurality of information objects, such that at least one attribute of the identified information object is not associated with at least one textual annotation; identifying one or more candidate textual annotations to be associated with the attribute, such that each candidate textual annotation is represented by a fragment of the natural language text referencing the value of the attribute; determining ranking scores of the identified candidate textual annotations; and selecting one or more candidate textual annotations having an optimal ranking score.

In accordance with one or more aspects of the present disclosure, an example computer-readable non-transitory storage medium may comprise executable instructions that, when executed by a computer system, cause the computer system to: receive a natural language text; extract, from the natural language text, a plurality of information objects, wherein each information object is associated with one or more attributes; verify values of the attributes of the plurality of information objects; identify an information object of the plurality of information objects, such that at least one attribute of the identified information object is not associated with at least one textual annotation; and reconstruct a textual annotation associated with the attribute of the identified information object, wherein the textual annotation is represented by a fragment of the natural language text referencing a value of the attribute.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a flow diagram of one illustrative example of a method for adjusting parameters of a classifier function employed for evaluating attributes associated with information objects, in accordance with one or more aspects of the present disclosure;

FIG. 2 schematically illustrates an example linear classifier producing a dividing hyperplane in a hyperspace defined by values of F1 and F2 representing the features utilized for attribute extraction, in accordance with one or more aspects of the present disclosure;

FIGS. 3A-3B schematically illustrate example natural language documents 300A and 300B with extracted features associated with certain information objects, in accordance with one or more aspects of the present disclosure;

FIG. 4 depicts a flow diagram of one illustrative example of a method for reconstructing textual annotations associated with information objects, in accordance with one or more aspects of the present disclosure;

FIG. 5 schematically illustrates a semantic structure produced by analyzing an example sentence in accordance with one or more aspects of the present disclosure;

FIG. 6 schematically illustrates the information objects and facts that are extracted from the example sentence of FIG. 5 by systems and methods operating in accordance with one or more aspects of the present disclosure;

FIGS. 7A-7C schematically illustrate fragments of the semantic structure representing the example sentence;

FIGS. 8A-8C schematically illustrate production rules which are applied to the subset of the semantic structure representing the example sentence, in order to extract the information objects and facts, in accordance with one or more aspects of the present disclosure;

FIG. 9 depicts a flow diagram of one illustrative example of a method 400 for performing a syntactico-semantic analysis of a natural language sentence, in accordance with one or more aspects of the present disclosure;

FIG. 10 schematically illustrates an example of a lexico-morphological structure of a sentence, in accordance with one or more aspects of the present disclosure;

FIG. 11 schematically illustrates language descriptions representing a model of a natural language, in accordance with one or more aspects of the present disclosure;

FIG. 12 schematically illustrates examples of morphological descriptions, in accordance with one or more aspects of the present disclosure;

FIG. 13 schematically illustrates examples of syntactic descriptions, in accordance with one or more aspects of the present disclosure;

FIG. 14 schematically illustrates examples of semantic descriptions, in accordance with one or more aspects of the present disclosure;

FIG. 15 schematically illustrates examples of lexical descriptions, in accordance with one or more aspects of the present disclosure;

FIG. 16 schematically illustrates example data structures that may be employed by one or more methods implemented in accordance with one or more aspects of the present disclosure;

FIG. 17 schematically illustrates an example graph of generalized constituents, in accordance with one or more aspects of the present disclosure;

FIG. 18 illustrates an example syntactic structure corresponding to the sentence illustrated by FIG. 17;

FIG. 19 illustrates a semantic structure corresponding to the syntactic structure of FIG. 18;

FIG. 20 depicts a diagram of an example computer system implementing the methods described herein.

### DETAILED DESCRIPTION

Described herein are methods and systems for reconstructing textual annotations associated with information objects. The systems and methods described herein may be employed for training classifier models that are utilized for performing various information extraction tasks (including named entity recognition, fact extraction, etc.) in the context of various natural language processing applications, such as machine translation, semantic indexing, semantic search (including multi-lingual semantic search), document classification, e-discovery, etc.

“Computer system” herein shall refer to a data processing device having a general purpose processor, a memory, and at least one communication interface. Examples of computer systems that may employ the methods described herein include, without limitation, desktop computers, notebook computers, tablet computers, and smart phones.

Information extraction may involve analyzing a natural language text to recognize information objects (such as named entities), their attributes, and their relationships. Named entity recognition (NER) is an information extraction task that locates and classifies natural language text tokens into pre-defined categories such as names of persons, organizations, locations, expressions of times, quantities, monetary values, percentages, etc. Such categories may be represented by concepts of a pre-defined or dynamically built ontology.

“Ontology” herein shall refer to a model representing objects pertaining to a certain branch of knowledge (subject area) and relationships among such objects. An information object may represent a real life material object (such as a person or a thing) or a certain notion associated with one or more real life objects (such as a number or a word). An ontology may comprise definitions of a plurality of classes, such that each class corresponds to a certain notion pertaining to a specified knowledge area. Each class definition may comprise definitions of one or more objects associated with the class. Following the generally accepted terminology, an ontology class may also be referred to as concept, and an object belonging to a class may also be referred to as an instance of the concept. An object may be characterized by one or more attributes. An attribute may specify a property of an information object or a relationship between a given information object and another information object. Thus, an ontology class definition may comprise one or more attribute definitions describing the types of attributes that may be associated with objects of the given class (e.g., type of relationships between objects of the given class and other information objects). In an illustrative example, a class “Person” may be associated with one or more information objects corresponding to certain persons. In another illustrative example, an information object “John Smith” may have an attribute “Smith” of the type “surname.”

Some attributes may be optional, while other attributes may be necessary for all informational objects of a given class. An information object may have one or more attributes of a given type. Certain attributes may only have a value selected from a set of one or more pre-defined values for all information objects of a given class.

Once the named entities have been recognized, the information extraction may proceed to resolve co-references and anaphoric links between natural text tokens. “Co-reference” herein shall mean a natural language construct involving two or more natural language tokens that refer to the same entity (e.g., the same person, thing, place, or organization). For example, in the sentence “Upon his graduation from MIT, John was offered a position by Microsoft,” the proper noun “John” and the possessive pronoun “his” refer to the same person. Out of two co-referential tokens, the referenced token may be referred to as the antecedent, and the referring one as a proform or anaphora. Various methods of resolving co-references may involve performing syntactic and/or semantic analysis of at least a part of the natural language text.

Once the information objects have been extracted and co-references have been resolved, the information extraction may proceed to identify relationships between the extracted information objects. One or more relationships between the information object and other information objects may be specified by one or more properties of an information object that are reflected by one or more attributes. A relationship may be established between two information objects, between a given information object and a group of information objects, or between one group of information objects and another group of information objects. Such relationships and attributes may be expressed by natural language fragments (textual annotations) that may comprise a plurality of words of one or more sentences.

In an illustrative example, an information object of the class “Person” may have, among others, the following attributes: name, date of birth, residential address, and employment history. Each attribute may be represented by one or more textual strings, one or more numeric values, and/or one or more values of a specified data type (e.g., date). An attribute may be represented by a complex attribute referencing two or more information objects. In an illustrative example, the “address” attribute may reference information objects representing a numbered building, a street, a city, and a state. In an illustrative example, the “employment history” attribute may reference one or more information objects representing one or more employers and associated positions and employment dates.

Certain relationships among information objects may be also referred to as “facts.” Examples of such relationships include employment of person X by organization Y, location of a physical object X in geographical position Y, acquiring of organization X by organization Y, etc. a fact may be associated with one or more fact categories, such that a fact category indicates a type of relationship between information objects of specified classes. For example, a fact associated with a person may be related to the person's birth, education, occupation, employment, etc. In another example, a fact associated with a business transaction may be related to the type of transaction and the parties to the transaction, the obligations of the parties, the date of signing the agreement, the date of the performance, the payments under the agreement, etc. Fact extraction involves identifying various relationships among the extracted information objects.

An information object may be referenced by one or more fragments of a natural language text, also referred to as “natural language tokens,” such that each natural language token may comprise one or more natural language words of one or more sentences. Text fragments, or tokens, referencing an information object are referred to herein as “object annotations.” Text fragments, or tokens, referencing an attribute of an information object are referred to herein as “attribute annotations.” An annotation may be specified by its position in the text, including the starting position and the ending position.

Annotated natural language texts (e.g., one or more natural language texts with annotations specifying information object types) may be employed for determining values of parameters of machine learning models (e.g., classifier functions that produce values reflecting degrees of association of an input syntactico-semantic structure with a certain information object class, relationship type, or fact category). The trained machine learning models may be employed for performing various natural language processing operations, such as named entity recognition, information object extraction, fact extraction, machine translation, semantic search, etc.

However, certain annotated natural language texts may only be accompanied by specifications of types and relationships of various information objects represented by the texts, while failing to specify at least some of textual annotations indicating positions of the natural language fragments corresponding to the extracted information objects. In an illustrative example, at least some of textual annotations associated with a natural language text may be lost in the process of user's verification of extracted information, which may involve confirming or correcting an ontology class associated with an information object, relationship type, or attribute type or value. User's correction of any of the extracted information can invalidate the corresponding textual annotations which have been previously associated with incorrectly determined ontology class, relationship type, or attribute type or value.

Systems and methods of the present disclosure allow reconstructing textual annotations associated with information objects and/or information object attributes. In an illustrative example, a computer system implementing the method of reconstructing textual annotations may receive a natural language text and a corresponding set of information objects with the respective attribute values. The computer system may traverse the attributes with missing annotations, and for each attribute may identify one or more candidate annotations, such that each candidate annotation may be represented by a fragment of the natural language text. In certain implementations, the candidate annotations may be identified by performing a fuzzy search of the attribute value in the natural language text. The computer system may further evaluate one or more ranking criteria for the identified candidate annotations and select one or more candidate annotations having the optimal (e.g., maximal or minimal) value of the ranking score. For each selected annotation, the attribute value may be associated with the starting and ending position of the corresponding natural text fragment in the natural language text, as described in more detail herein below.

Various aspects of the above referenced methods and systems are described in details herein below by way of examples, rather than by way of limitation.

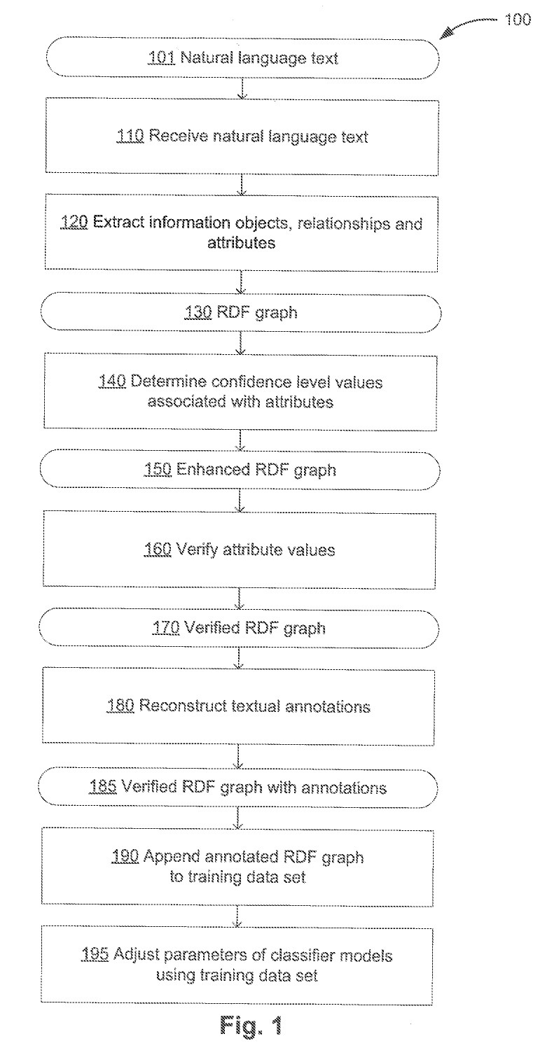

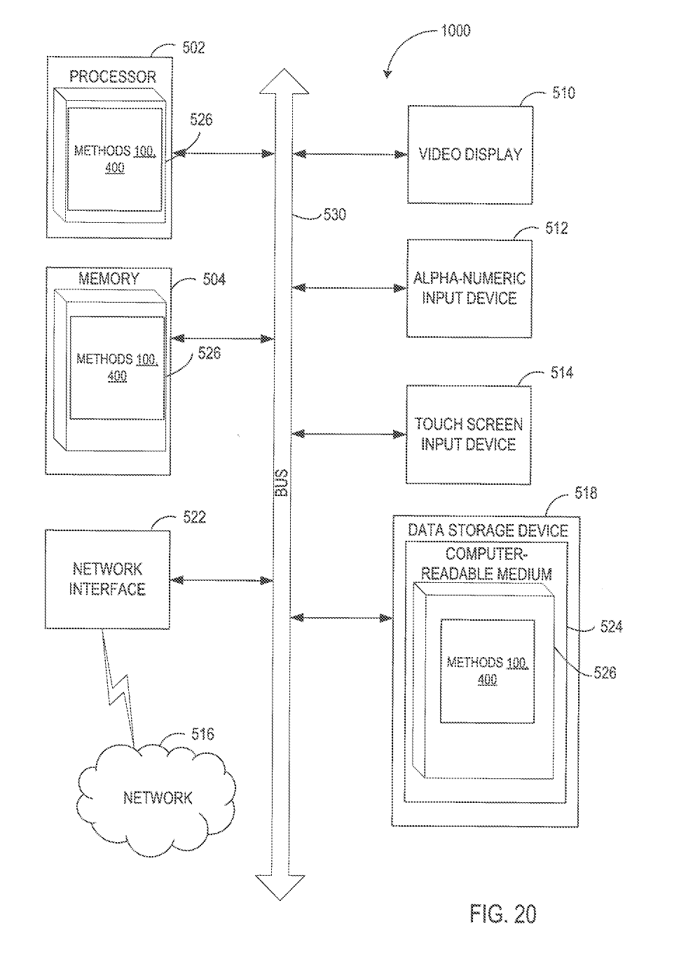

FIG. 1 depicts a flow diagram of one illustrative example of a method for adjusting parameters of a classifier function employed for evaluating attributes associated with information objects, in accordance with one or more aspects of the present disclosure. Method 100 and/or each of its individual functions, routines, subroutines, or operations may be performed by one or more processors of the computer system (e.g., computer system 1000 of FIG. 20) implementing the method. In certain implementations, method 100 may be performed by a single processing thread. Alternatively, method 100 may be performed by two or more processing threads, each thread implementing one or more individual functions, routines, subroutines, or operations of the method. In an illustrative example, the processing threads implementing method 100 may be synchronized (e.g., using semaphores, critical sections, and/or other thread synchronization mechanisms). Alternatively, the processing threads implementing method 100 may be executed asynchronously with respect to each other.

At block 110, a computer system implementing the method may receive a natural language text 101 (e.g., a document or a collection of documents). In an illustrative example, the computer system may receive the natural language text in the form of an electronic document which may be produced by scanning or otherwise acquiring an image of a paper document and performing optical character recognition (OCR) to produce the document text. In another illustrative example, the computer system may receive the natural language text in the form of one or more formatted files, such as word processing files, electronic mail messages, digital content files, etc.

At block 120, the computer system may perform one or more information extraction operations with respect to the natural language text. The information extraction operations may include identifying information objects represented by the natural language text and pertaining to one or more specified classes, identifying relationships of one or more types among the identified information objects, extracting facts of one or more category with respect to the identified information objects, and/or identifying attributes pertaining to the identified information objects.

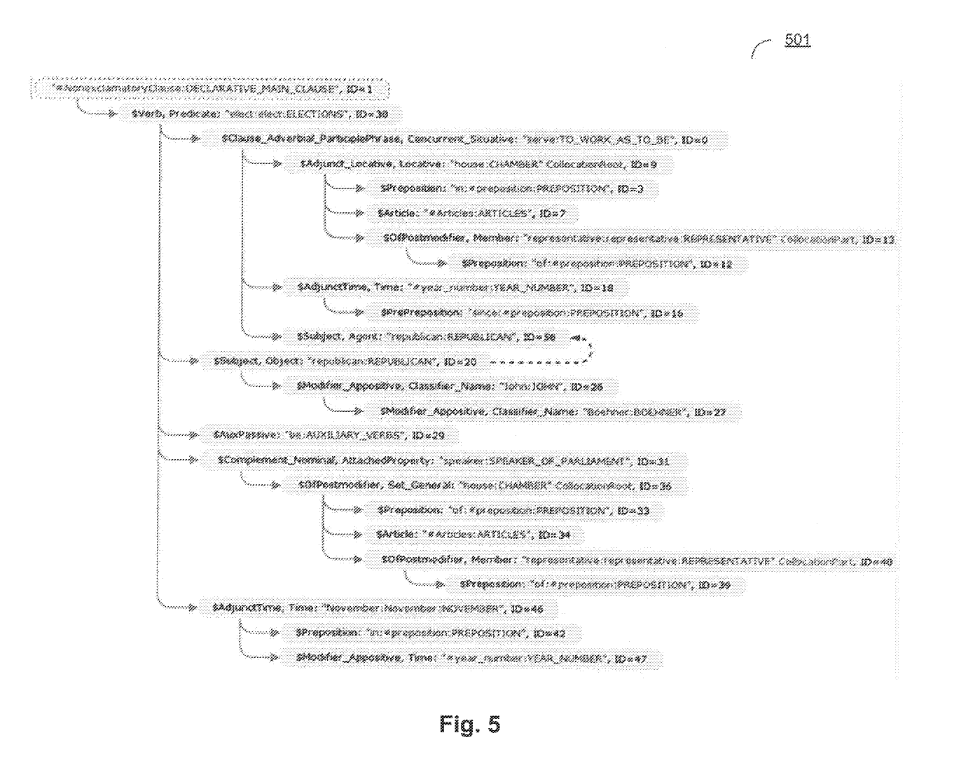

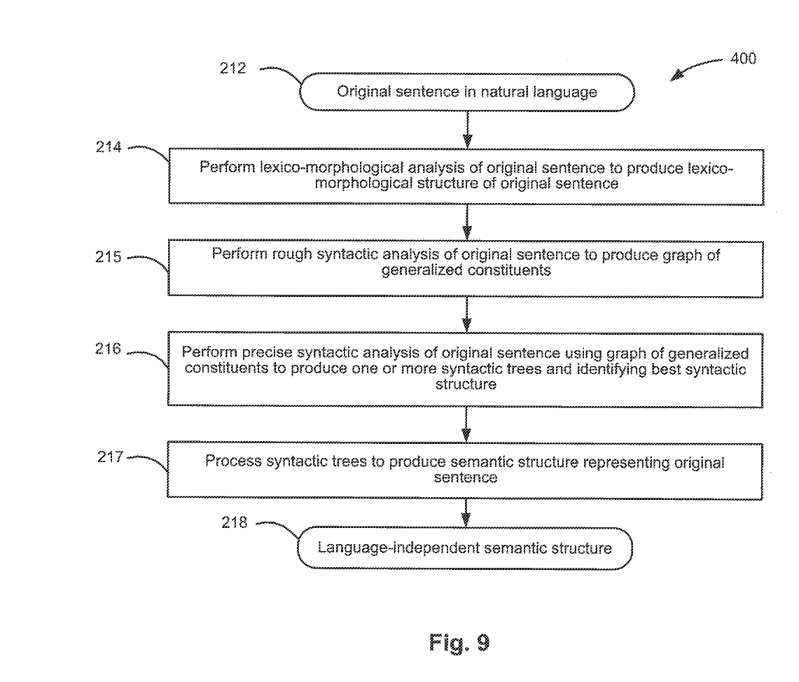

In certain implementations, the information extraction operations may be performed by analyzing a plurality of syntactico-semantic structures representing the natural language text, which may be produced by syntactico-semantic analysis of the natural language text. The syntactico-semantic analysis may yield a plurality of semantic structures, such that each semantic structure would represent a corresponding natural language sentence, as described in more detail herein above with references to FIGS. 5-15. A semantic structure may be represented by an acyclic graph that includes a plurality of nodes corresponding to semantic classes and a plurality of edges corresponding to semantic relationships, as described in more detail herein below with reference to FIG. 9. For simplicity, any subset of a semantic structure shall be referred herein as a “structure” (rather than a “substructure”), unless the parent-child relationship between two semantic structures is at issue.

In certain implementations, the computer system implementing the method may interpret the plurality of semantic structures using a set of production rules to extract a plurality of objects representing the identified information objects. The extracted objects may be represented by a Resource Definition Framework (RDF) graph 130. The Resource Definition Framework assigns a unique identifier to each information object and stores the information regarding such an object in the form of SPO triplets, where S stands for “subject” and contains the identifier of the object, P stands for “predicate” and identifies some property of the object, and O stands for “object” and stores the value of that property of the object. This value can be either a primitive data type (string, number, Boolean value) or an identifier of another object. In an illustrative example, an SPO triplet may associate an information object with an attribute value.

The production rules employed for interpreting the semantic structures may comprise interpretation rules and identification rules. An interpretation rule may comprise a left-hand side represented by a set of logical expressions defined on one or more semantic structure templates and a right-hand side represented by one or more statements regarding the information objects representing the entities referenced by the natural language text.

A semantic structure template may comprise certain semantic structure elements (e.g., association with a certain lexical or semantic class, association with a certain surface or deep slot, the presence of a certain grammeme or semanteme etc.). The relationships between the semantic structure elements may be specified by one or more logical expressions (conjunction, disjunction, and negation) and/or by operations describing mutual positions of nodes within the syntactico-semantic tree. In an illustrative example, such an operation may verify whether one node belongs to a subtree of another node.

Matching the template defined by the left-hand side of a production rule to a semantic structure representing at least part of a sentence of the natural language text may trigger the right-hand side of the production rule. The right-hand side of the production rule may associate one or more attributes (reflecting lexical, syntactic, and/or semantic properties of the words of an original sentence) with the information objects represented by the nodes and/or determine values of one or more attributes. In an illustrative example, the right-hand side of an interpretation rule may comprise a statement associating an information object with a certain attribute value.

An identification rule may be employed to associate a pair of information objects which represent the same real world entity. An identification rule is a production rule, the left-hand side of which comprises one or more logical expressions referencing the semantic tree nodes corresponding to the information objects. If the pair of information objects satisfies the conditions specified by the logical expressions, the information objects are merged into a single information object.

In certain implementations, the computer system may further employ one or more classifier functions. A classifier function may produce a value reflecting the degree of association of an input syntactico-semantic structure with a certain information object class, relationship type, or attribute value. In an illustrative example, a classifier function may be provided by an adaptive boosting (AdaBoost) with decision trees classifier. A decision tree algorithm uses a decision tree as a predictive model to map observed parameters of an item (e.g., lexical or grammatical features of a subset of a syntactico-semantic structure) to conclusions about the item target value (e.g., an attribute value associated with an information object referenced by the syntactico-semantic structure). The method may operate on a classification tree in which each internal node is labeled with an input feature (e.g., lexical or grammatical features of a subset of a syntactico-semantic structure). The edges connected to a node labeled with a feature are labeled with the possible values of the input feature. Each leaf of the tree is labeled with an identifier of a class (e.g., a value or a range of values of a certain attribute associated with an information object referenced by the syntactico-semantic structure) or the degree of association with the class.

Due to the inherent ambiguity of various natural language constructs, association of an attribute value with an informational object may not always be absolute, and thus may be characterized by the confidence level, which may be expressed by a numeric value on a given scale (e.g., by a real number from a range of 0 to 1). In accordance with one or more aspects of the present disclosure, at block 140, the computer system implementing the method may determine the confidence level values associated with certain attributes. In an illustrative example, the computer system may evaluate a confidence function associated with classifier functions and/or production rules that have been employed for producing the attribute. The function domain for estimating a confidence level of a given attribute may be represented by one or more arguments reflecting various aspects of the information extraction process referenced by block 120. Such arguments may include, for example, identifiers of classifier functions and/or production rules that have been employed to produce the given attribute and/or related attributes, reliability scores of classifier functions and/or production rules that have been employed to produce the given attribute and/or related attributes, rating values of one or more language-independent semantic structures that have been produced by the syntactico-semantic analysis of the natural language text, certain features of semantic classes produced by the syntactic and semantic analysis of the sentence referencing the information object that is characterized by the given attribute, and/or other features of the information extraction process. In certain implementations, the computer system may enhance the data objects representing the natural language text (e.g., RDF graph 130) by associating confidence level values with the object attributes, thus producing an enhanced RDF graph 150.

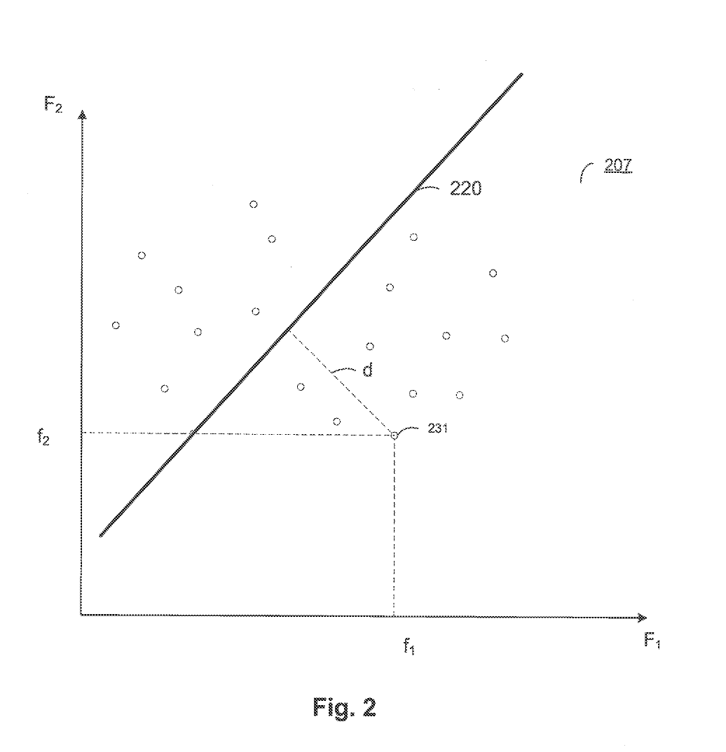

In certain implementations, the confidence function may be represented by a linear classifier producing a distance from the informational object to a dividing hyperplane in a hyperspace of features which have been utilized for extracting attributes. FIG. 2 schematically illustrates an example linear classifier producing a dividing hyperplane represented by a plane 220 in a hyperspace represented by a two-dimensional space 207, which may be defined by values of F1 and F2 representing the features which have been utilized for extracting attributes. Therefore, each object may be represented by a point in the two-dimensional space 207, such that the point coordinates represent the values of F1 and F2, respectively. For example, and object having the feature values F1=f1 and F2=f2 may be represented by point 231 having the coordinates of (f1, f2). In accordance with one or more aspects of the present invention, the distance between a particular object and the dividing hyperplane 220 in hyperspace 207, as shown on FIG. 2, may be indicative of the confidence level associated with the object attribute that has been identified by the information extraction process referenced by block 140.

Values of the parameters of the linear classifier may be determined by applying machine learning methods. In certain implementations, a training data set utilized by the machine learning methods may comprise one or more of natural language texts, in which for certain objects their respective attribute values are specified (e.g., class or concept of an ontology associated with certain words are marked up in the text). The computer system may iteratively identify values of the linear classifier parameters that would optimize a chosen objective function (e.g., maximize a fitness function reflecting the number of natural language texts that would be classified correctly using the specified values of the linear classifier parameters).

Referring again to FIG. 1, at block 160, the identified attribute values may be verified via a graphical user interface (GUI) employed to display an information object with one or more associated attributes and receive a user input confirming or modifying the association of a selected attribute to a certain information object and/or a user input confirming or modifying an attribute value. In an illustrative example, the GUI may include one or more checkboxes for confirming the association of the selected attribute to the information object or confirming the displayed attribute value. In another illustrative example, the GUI may include one or more radio buttons for confirming the association of the selected attribute to the information object or selecting one of the displayed attribute values. In another illustrative example, the GUI may include a drop-down list for selecting one of the displayed attribute values.

In certain implementations, the attributes, confidence level of which falls below a certain threshold, may be highlighted, enclosed by bounding rectangles, visually associated with pre-defined symbols or icons (“T”), or otherwise visually distinguished. In certain implementations, the threshold confidence level may be user-selectable by a slider GUI control. Alternatively, the threshold confidence level may be automatically set by the computer system implementing the method, and may, for example, be incrementally increased one or more times after receiving the user's indication of the completion of the verification process at the current confidence level. Since the most number of errors would presumably be detected at the lowest confidence levels, the number of errors would be decreasing as the confidence level increases, and thus the verification process may be terminated when the ratio of the number of errors to the number of correctly determined attributes falls below a pre-defined or dynamically determined threshold level.

Responsive to receiving the user's indication of the completion of the verification process, the computer system may produce the verified RDF graph 170 representing the source natural language text 101.

Thus, the verification process may modify ontology classes, relationship types, attribute types, or attribute values associated with one or more information objects, which may lead to invalidating the associated textual annotations which have been previously associated with incorrectly determined ontology class, relationship type, or attribute type or value. Furthermore, an attribute value may have a spelling which is different from the spelling of the associated fragment of the natural language text, which may be caused, e.g., by optical character recognition (OCR) errors leading to missing punctuation marks or different capitalization of one or more words.

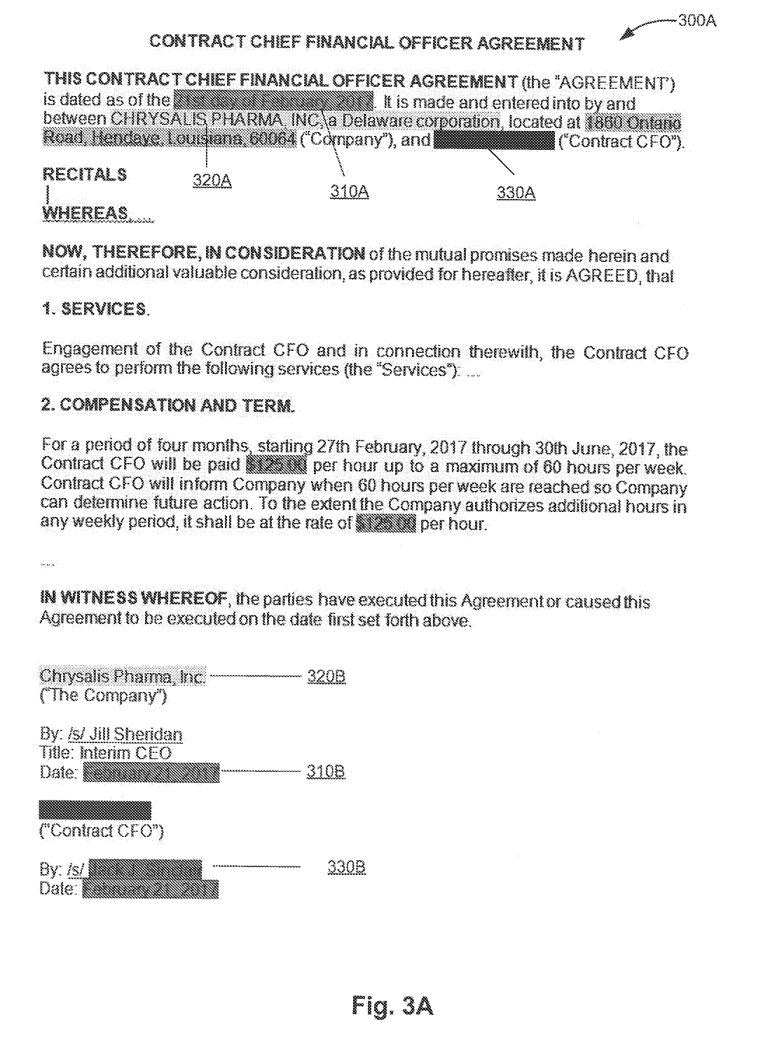

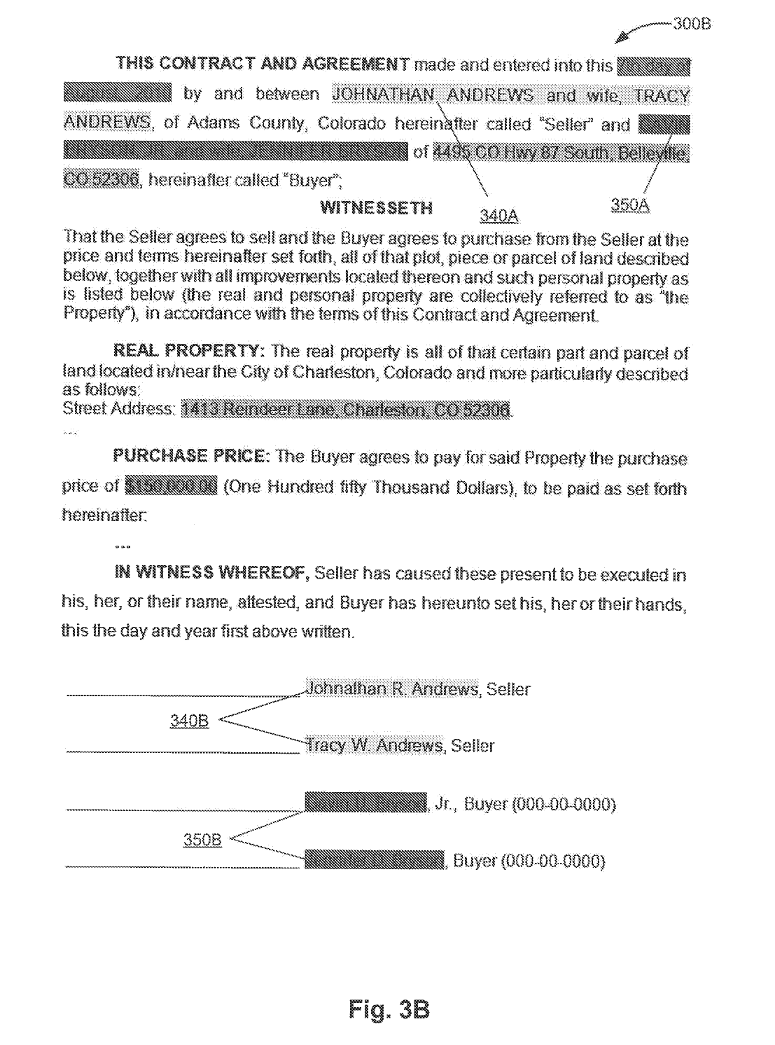

FIGS. 3A-3B schematically illustrate example natural language documents 300A and 300B with extracted features associated with certain information objects. Each of the documents is a source of a certain fact, e.g., a purchase transaction. The sides to the transaction, their addresses and other identifiers, the amounts of consideration are interpreted as attributes of associated with the information object representing the purchase transaction. The documents 300A and 300B may have passed the user verification of the attribute assignment, and may contain various discrepancies caused by OCR errors and/or by differences in spelling of certain attributes, each of which is referenced at least twice by the natural language text.

In the illustrative example of FIG. 3A, the agreement execution date is referenced by two textual fragments 310A and 310B, which differ in the order of words; the name of the first party is referenced by two textual fragments 320A and 320B, which differ in the capitalization; and the name of the second party is referenced by two textual fragments 330A and 330B, which also differ in the capitalization. In the illustrative example of FIG. 3B, the name of the first party is referenced by two textual fragments 340A and 340B, which differ in wording and capitalization; and the name of the second party is referenced by two textual fragments 350A and 350B, which also differ in wording and capitalization. Therefore, the method of reconstructing the annotations should be able to account for the noted and other irregularities and variations of the input natural language text.

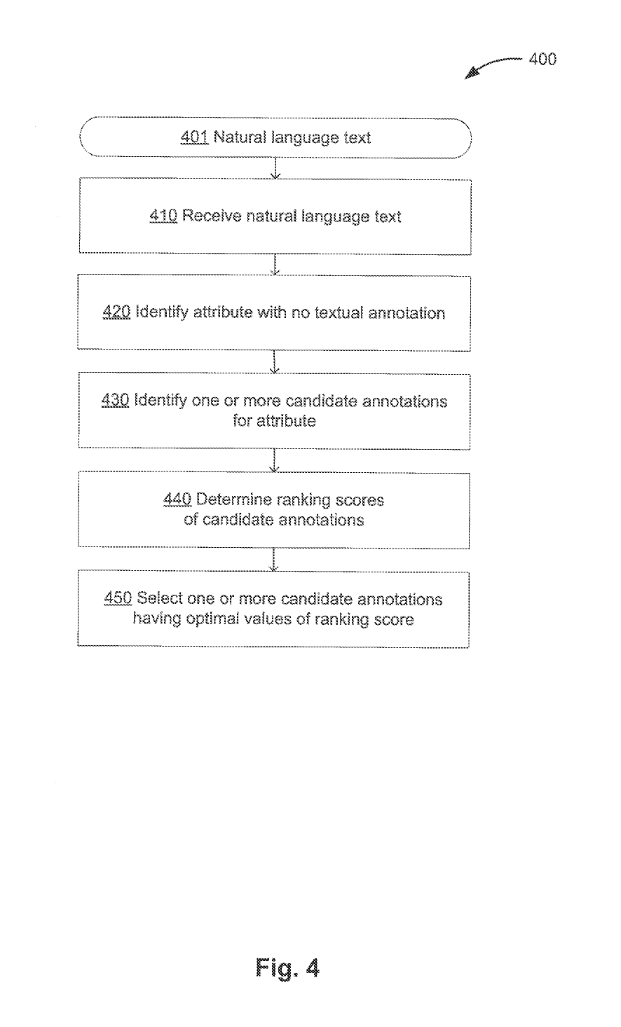

At block 180, the computer system implementing the method may reconstruct one or more textual annotations associated with information objects and/or information object attributes, as described in more detail herein below with references to FIG. 4. Reconstructing the annotations may result in producing the verified RDF graph with reconstructed annotations 185. In certain implementations, the RDF graph 185 may further comprise the ranking scores associated with the reconstructed textual annotations.

At block 190, the RDF graph 185 may be appended to a training data set which, at block 195, may be utilized for adjusting parameters of one or more classifier models employed for evaluating attributes associated with information objects.

FIG. 4 depicts a flow diagram of one illustrative example of a method for reconstructing textual annotations associated with information objects, in accordance with one or more aspects of the present disclosure. Method 400 and/or each of its individual functions, routines, subroutines, or operations may be performed by one or more processors of the computer system (e.g., computer system 1000 of FIG. 20) implementing the method. In certain implementations, method 400 may be performed by a single processing thread. Alternatively, method 400 may be performed by two or more processing threads, each thread implementing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other.

At block 410, the computer system implementing the method receive a natural language text and a corresponding set of information objects with the respective attribute values (e.g., represented by an enhanced RDF graph), as described in more detail herein above.

At blocks 420-450, the computer system may traverse a plurality of attributes associated with information objects extracted from a natural language text. Responsive to determining, at block 420, that no textual annotation is associated with the attribute, the computer system may, at block 430, identify one or more candidate annotations to be associated with the attribute, such that each candidate annotation may be represented by a fragment of the natural language text. In certain implementations, the candidate annotations may be identified by performing a fuzzy search of the attribute value in the natural language text. In an illustrative example, the fuzzy search may be based on the root morpheme of the attribute value (i.e., the attribute value which has been stripped of one or more the endings and/or suffixes). In an illustrative example, the fuzzy search may be based on one or more synonymic expressions associated with the attribute value.

Notably, the fuzzy search-based identification of textual annotations may be hindered by the fact that two or more informational objects extracted from the natural language text may have identical or similar attribute values, and/or several attributes of a single information object may have identical or similar attribute values. Therefore, at block 440 the computer system may evaluate one or more ranking criteria for the identified candidate annotations. In an illustrative example, a ranking score produced by evaluating a ranking criterion may reflect the distance, in the natural language text, between the candidate annotation and the text token corresponding to the information object which is being annotated. In another illustrative example, a ranking score may reflect the presence of other attributes within a pre-defined distance of the text token corresponding to the information object which is being annotated. In another illustrative example, a ranking score may be produced by a classifier model, which has been trained on a training data set including one or more natural language texts of the same category as the natural language text that is being analyzed. The parameters of such a classifier model may be further adjusted using one or more verified natural language texts with reconstructed attributes.

At block 450, one or more candidate annotations having the optimal (e.g., maximal or minimal) value of the ranking score may be selected for each information object attribute. For each selected annotation, the attribute value may be associated with the starting and ending position of the corresponding natural text fragment in the natural language text.

FIG. 5 schematically illustrates a semantic structure 501 representing an example sentence: “Serving in the House of Representatives since 1990, Republican John Boehner was elected Speaker of the House of Representatives in November 2010.”

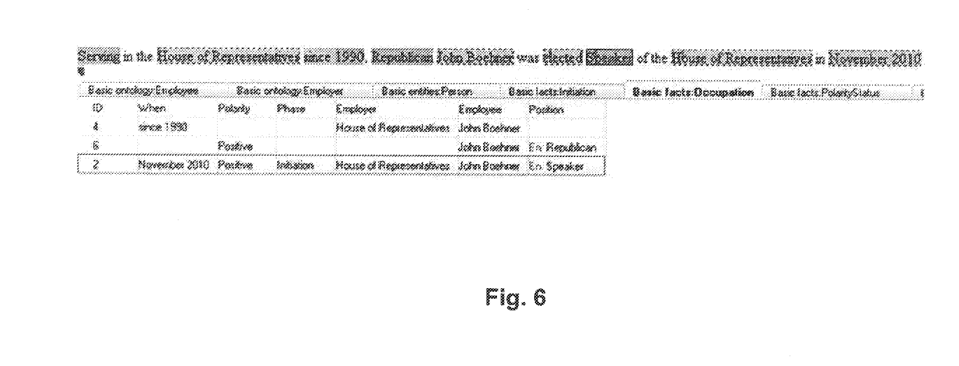

FIG. 6 schematically illustrates the information object (represented by named entities) and facts that are extracted from the example sentence by systems and methods operating in accordance with one or more aspects of the present disclosure. As illustrated by FIG. 6, the fact of category “Employment” associates the named entities of categories “Person” and “Employer.”

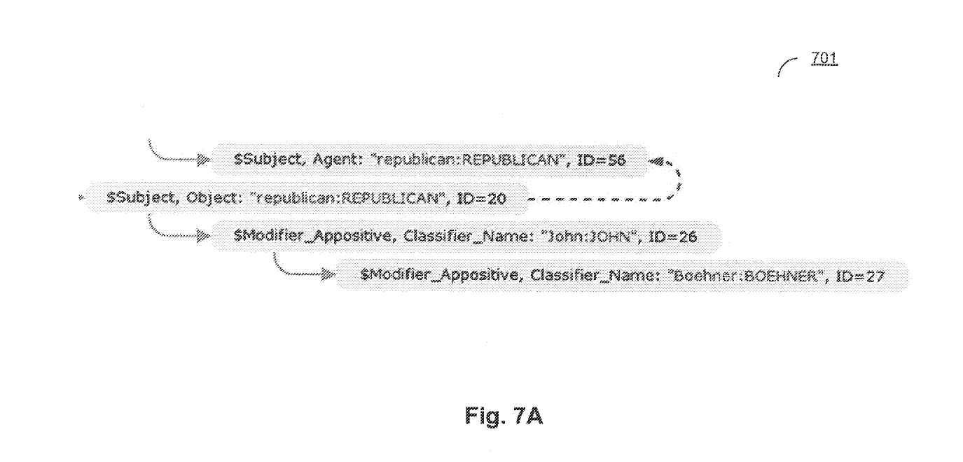

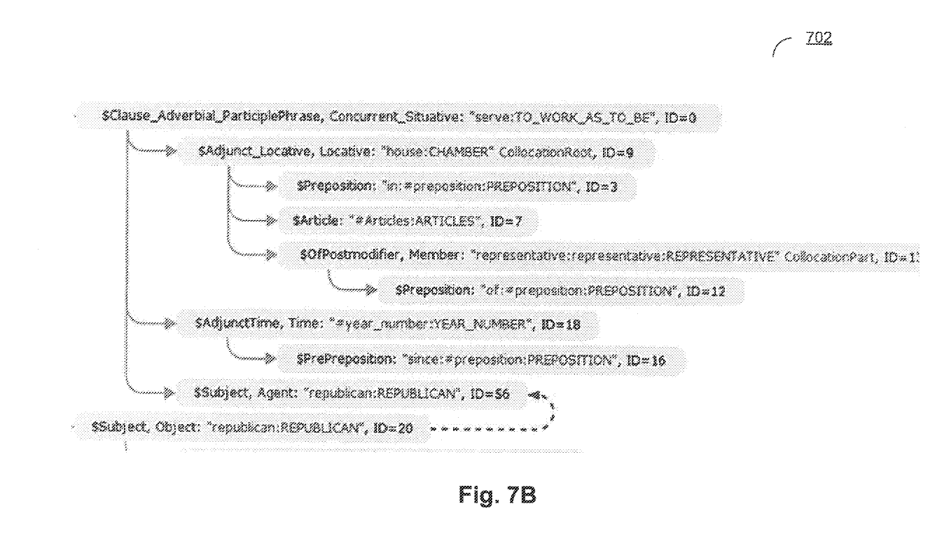

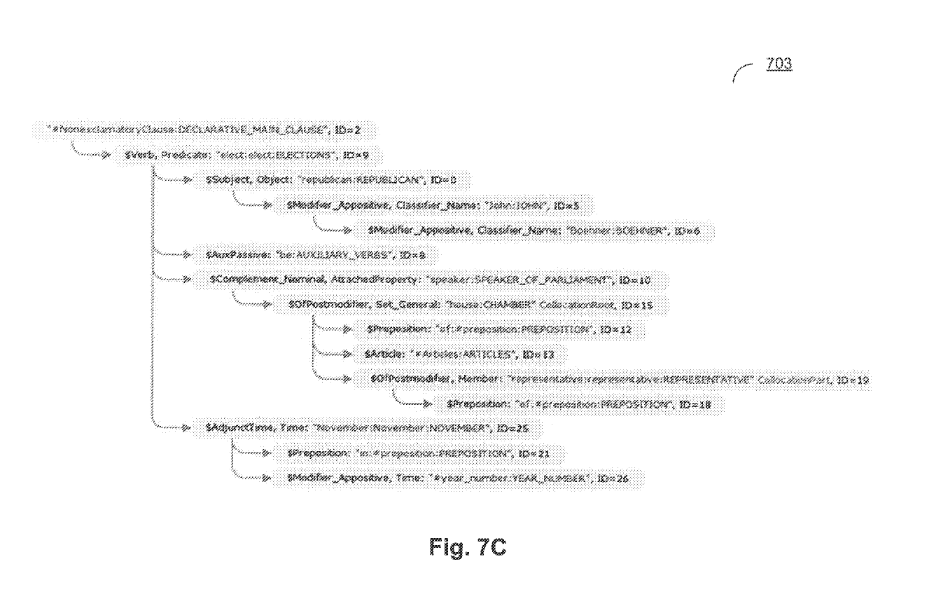

FIGS. 7A-7C schematically illustrate fragments 701, 702, and 703 of the semantic structure 501 representing the example sentence, to which the production rules are applied in order to extract the named entities and facts.

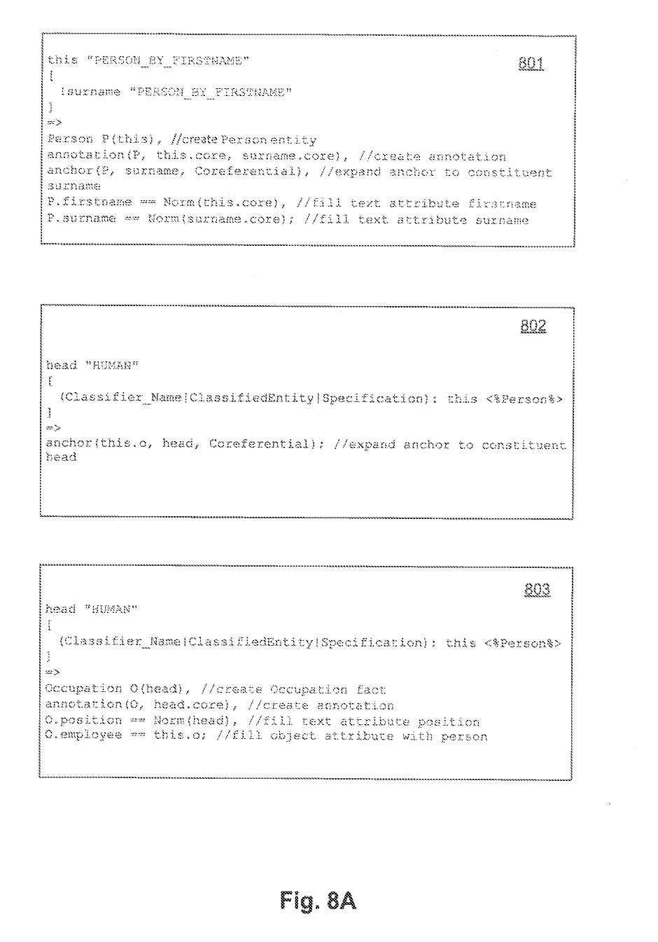

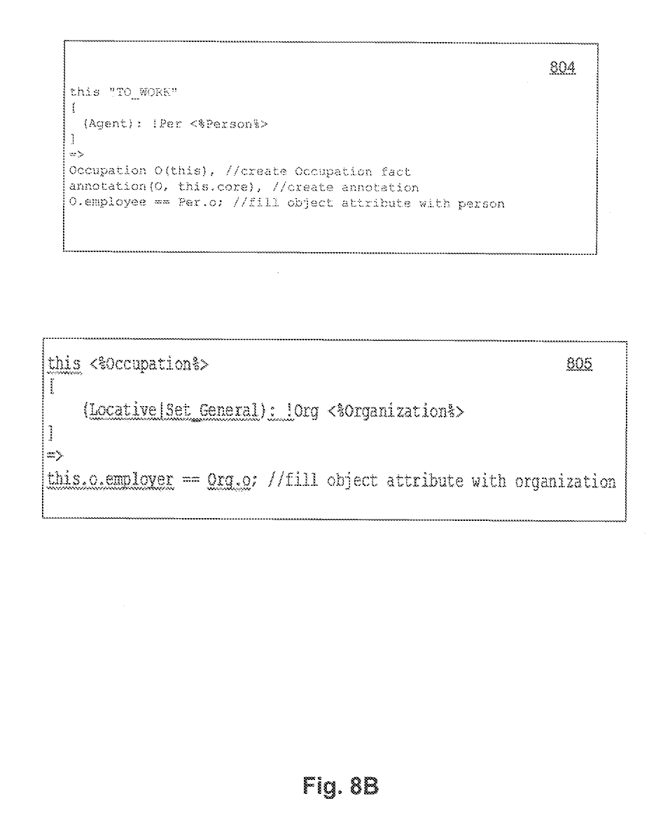

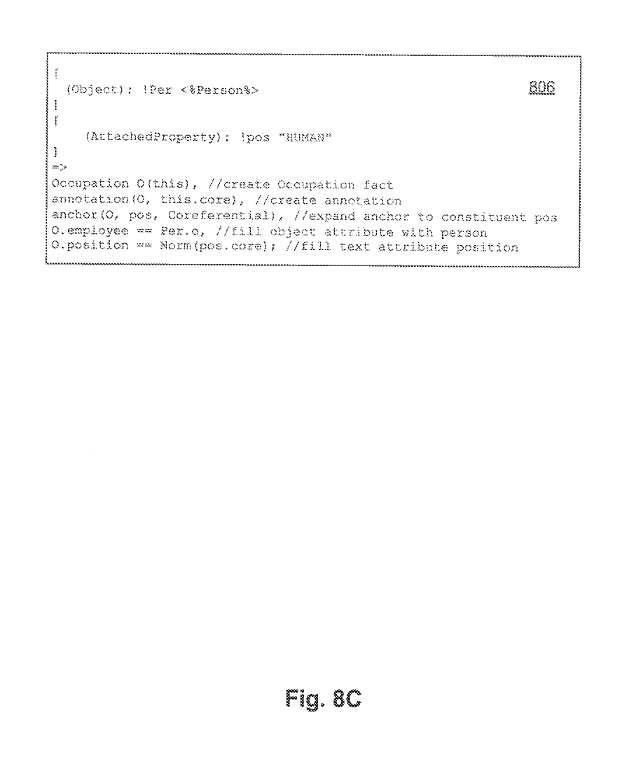

FIGS. 8A-8C schematically illustrate production rules which are applied to the subset of the semantic structure representing the example sentence of FIG. 5, in order to extract the information objects and facts. Rules 801-803 are applied to the semantic structure 701. Rule 801 extracts the named entity of category Person. Rule 802 at least partially resolves a co-reference associated with the named entity being extracted. Rule 803 associates the extracted named entities (Person and Employer) by a relationship indicating the employment of the Person by the Employer. Rules 804-805 are applied to the semantic structure 701. Rule 804 creates a fact of a category Occupation, associating the extracted named entities. Rule 805 associates the Employer attribute of the created fact with the extracted named entity of the category “Organization.” Rules 806 and 805 are applied to the semantic structure 703. Rule 806 creates a fact of a category Occupation, associating the extracted named entities.

FIG. 9 depicts a flow diagram of one illustrative example of a method 400 for performing a syntactico-semantic analysis of a natural language sentence 212, in accordance with one or more aspects of the present disclosure. Method 400 may be applied to one or more syntactic units (e.g., sentences) comprised by a certain text corpus, in order to produce a plurality of syntactico-semantic trees corresponding to the syntactic units. In various illustrative examples, the natural language sentences to be processed by method 400 may be retrieved from one or more electronic documents which may be produced by scanning or otherwise acquiring images of paper documents and performing optical character recognition (OCR) to produce the texts associated with the documents. The natural language sentences may be also retrieved from various other sources including electronic mail messages, social networks, digital content files processed by speech recognition methods, etc.

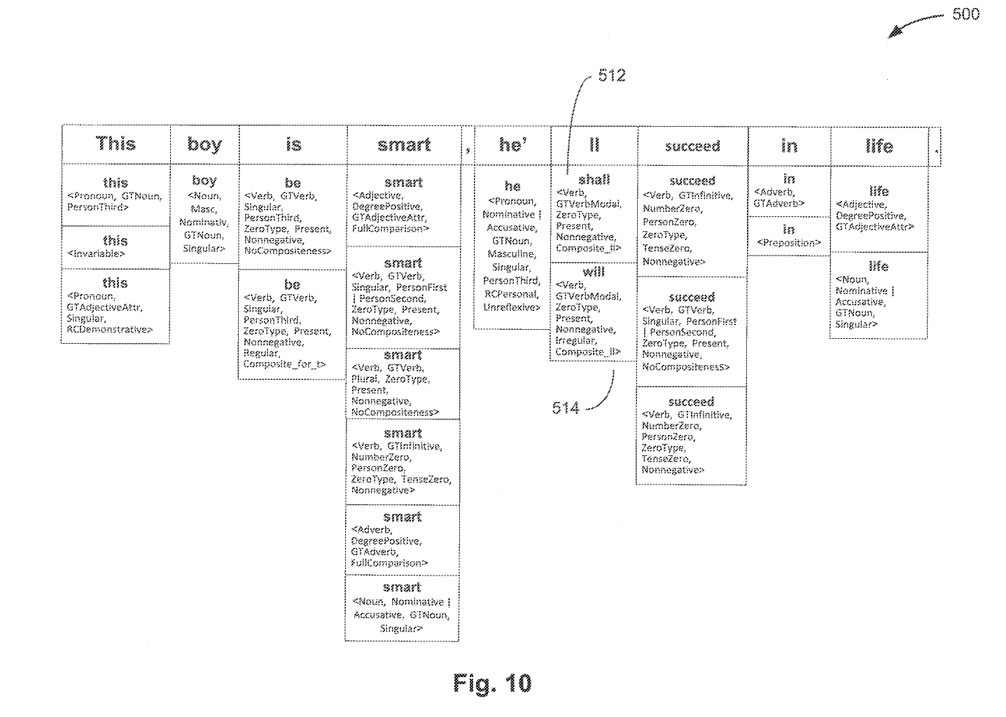

At block 214, the computer system implementing the method may perform lexico-morphological analysis of sentence 212 to identify morphological meanings of the words comprised by the sentence. “Morphological meaning” of a word herein shall refer to one or more lemma (i.e., canonical or dictionary forms) corresponding to the word and a corresponding set of values of grammatical attributes defining the grammatical value of the word. Such grammatical attributes may include the lexical category of the word and one or more morphological attributes (e.g., grammatical case, gender, number, conjugation type, etc.). Due to homonymy and/or coinciding grammatical forms corresponding to different lexico-morphological meanings of a certain word, two or more morphological meanings may be identified for a given word. An illustrative example of performing lexico-morphological analysis of a sentence is described in more detail herein below with references to FIG. 10.

At block 215, the computer system may perform a rough syntactic analysis of sentence 212. The rough syntactic analysis may include identification of one or more syntactic models which may be associated with sentence 212 followed by identification of the surface (i.e., syntactic) associations within sentence 212, in order to produce a graph of generalized constituents. “Constituent” herein shall refer to a contiguous group of words of the original sentence, which behaves as a single grammatical entity. A constituent comprises a core represented by one or more words, and may further comprise one or more child constituents at lower levels. A child constituent is a dependent constituent and may be associated with one or more parent constituents.

At block 216, the computer system may perform a precise syntactic analysis of sentence 212, to produce one or more syntactic trees of the sentence. The pluralism of possible syntactic trees corresponding to a given original sentence may stem from homonymy and/or coinciding grammatical forms corresponding to different lexico-morphological meanings of one or more words within the original sentence. Among the multiple syntactic trees, one or more best syntactic tree corresponding to sentence 212 may be selected, based on a certain rating function talking into account compatibility of lexical meanings of the original sentence words, surface relationships, deep relationships, etc.

At block 217, the computer system may process the syntactic trees to the produce a semantic structure 218 corresponding to sentence 212. Semantic structure 218 may comprise a plurality of nodes corresponding to semantic classes, and may further comprise a plurality of edges corresponding to semantic relationships, as described in more detail herein below.

FIG. 10 schematically illustrates an example of a lexico-morphological structure of a sentence, in accordance with one or more aspects of the present disclosure. Example lexical-morphological structure 500 may comprise having a plurality of “lexical meaning-grammatical value” pairs for an example sentence. In an illustrative example, “II” may be associated with lexical meaning “shall” 512 and “will” 514. The grammatical value associated with lexical meaning 512 is <Verb, GTVerbModal, ZeroType, Present, Nonnegative, Composite II>. The grammatical value associated with lexical meaning 514 is <Verb, GTVerbModal, ZeroType, Present, Nonnegative, Irregular, Composite II>.

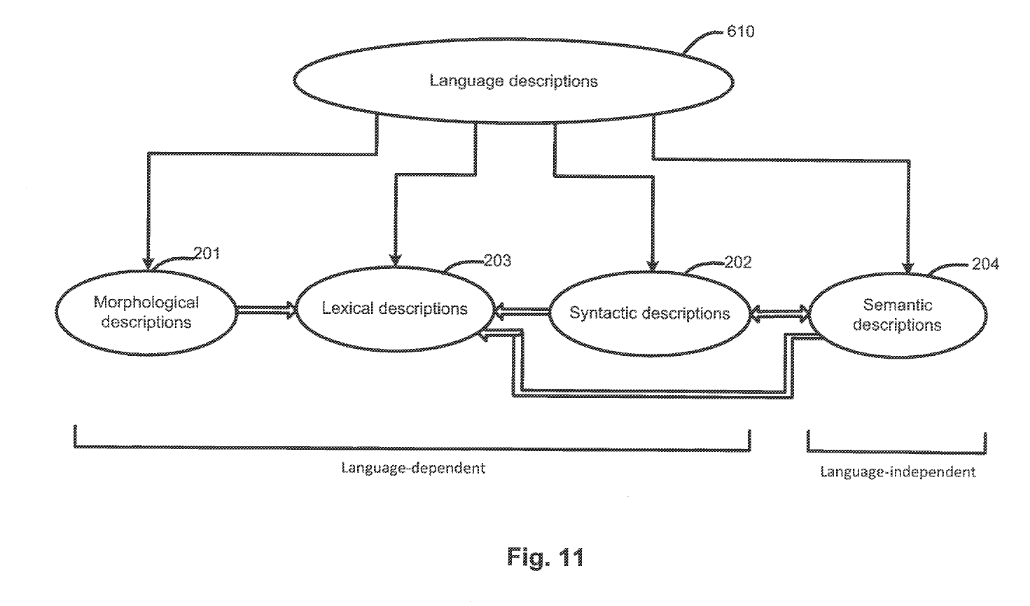

FIG. 11 schematically illustrates language descriptions 610 including morphological descriptions 201, lexical descriptions 203, syntactic descriptions 202, and semantic descriptions 104, and their relationship thereof. Among them, morphological descriptions 201, lexical descriptions 203, and syntactic descriptions 202 are language-specific. A set of language descriptions 610 represent a model of a certain natural language.

In an illustrative example, a certain lexical meaning of lexical descriptions 203 may be associated with one or more surface models of syntactic descriptions 202 corresponding to this lexical meaning. A certain surface model of syntactic descriptions 202 may be associated with a deep model of semantic descriptions 204.

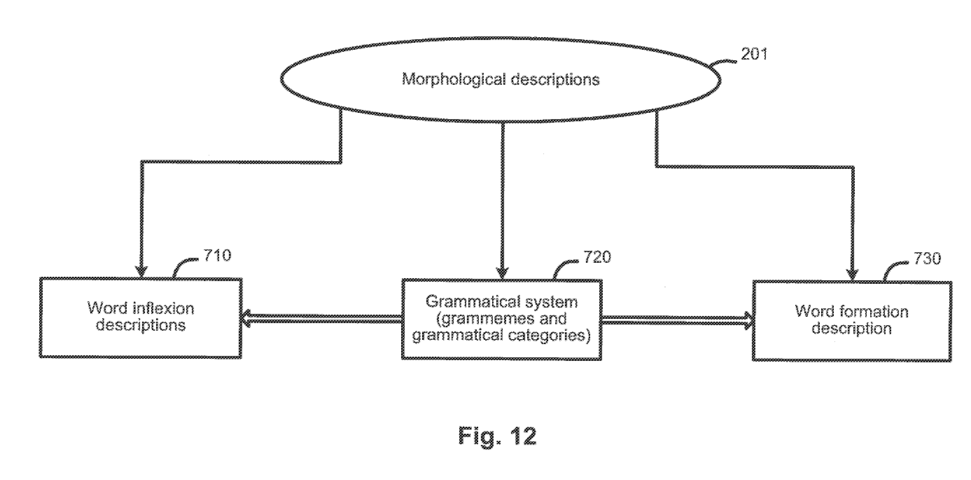

FIG. 12 schematically illustrates several examples of morphological descriptions. Components of the morphological descriptions 201 may include: word inflexion descriptions 710, grammatical system 720, and word formation description 730, among others. Grammatical system 720 comprises a set of grammatical categories, such as, part of speech, grammatical case, grammatical gender, grammatical number, grammatical person, grammatical reflexivity, grammatical tense, grammatical aspect, and their values (also referred to as “grammemes”), including, for example, adjective, noun, or verb; nominative, accusative, or genitive case; feminine, masculine, or neutral gender; etc. The respective grammemes may be utilized to produce word inflexion description 710 and the word formation description 730.

Word inflexion descriptions 710 describe the forms of a given word depending upon its grammatical categories (e.g., grammatical case, grammatical gender, grammatical number, grammatical tense, etc.), and broadly includes or describes various possible forms of the word. Word formation description 730 describes which new words may be constructed based on a given word (e.g., compound words).

According to one aspect of the present disclosure, syntactic relationships among the elements of the original sentence may be established using a constituent model. A constituent may comprise a group of neighboring words in a sentence that behaves as a single entity. A constituent has a word at its core and may comprise child constituents at lower levels. A child constituent is a dependent constituent and may be associated with other constituents (such as parent constituents) for building the syntactic descriptions 202 of the original sentence.

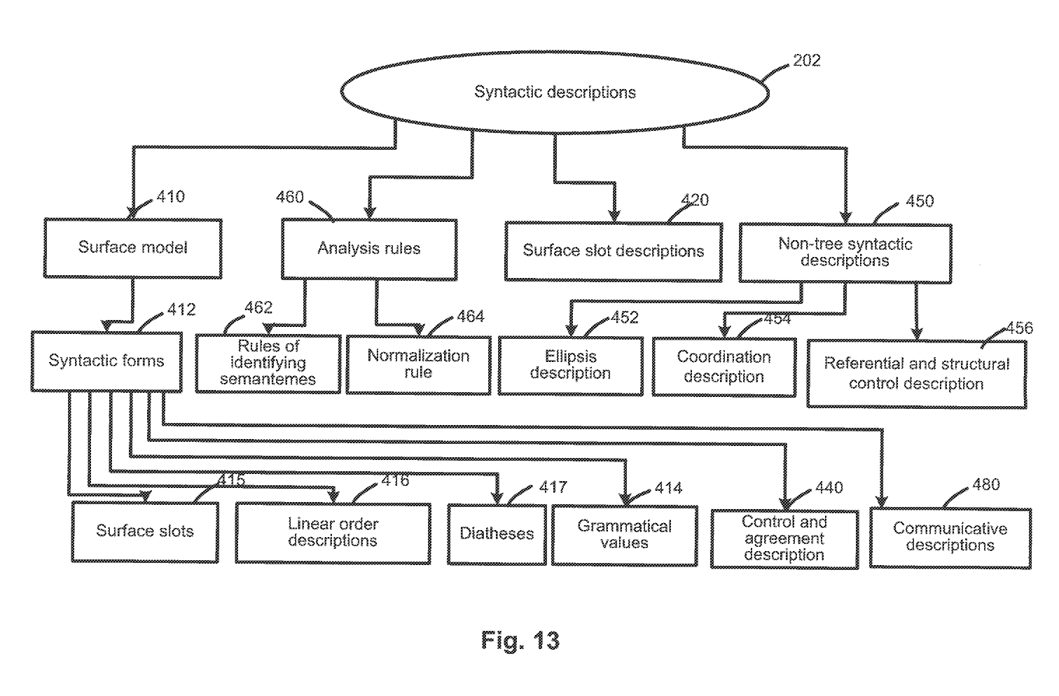

FIG. 13 illustrates exemplary syntactic descriptions. The components of the syntactic descriptions 202 may include, but are not limited to, surface models 410, surface slot descriptions 420, referential and structural control description 456, control and agreement description 440, non-tree syntactic description 450, and analysis rules 460. Syntactic descriptions 202 may be used to construct possible syntactic structures of the original sentence in a given natural language, taking into account free linear word order, non-tree syntactic phenomena (e.g., coordination, ellipsis, etc.), referential relationships, and other considerations.

Surface models 410 may be represented as aggregates of one or more syntactic forms (“syntforms” 412) employed to describe possible syntactic structures of the sentences that are comprised by syntactic description 102. In general, the lexical meaning of a natural language word may be linked to surface (syntactic) models 410. A surface model may represent constituents which are viable when the lexical meaning functions as the “core.” A surface model may include a set of surface slots of the child elements, a description of the linear order, and/or diatheses. “Diathesis” herein shall refer to a certain relationship between an actor (subject) and one or more objects, having their syntactic roles defined by morphological and/or syntactic means. In an illustrative example, a diathesis may be represented by a voice of a verb: when the subject is the agent of the action, the verb is in the active voice, and when the subject is the target of the action, the verb is in the passive voice.

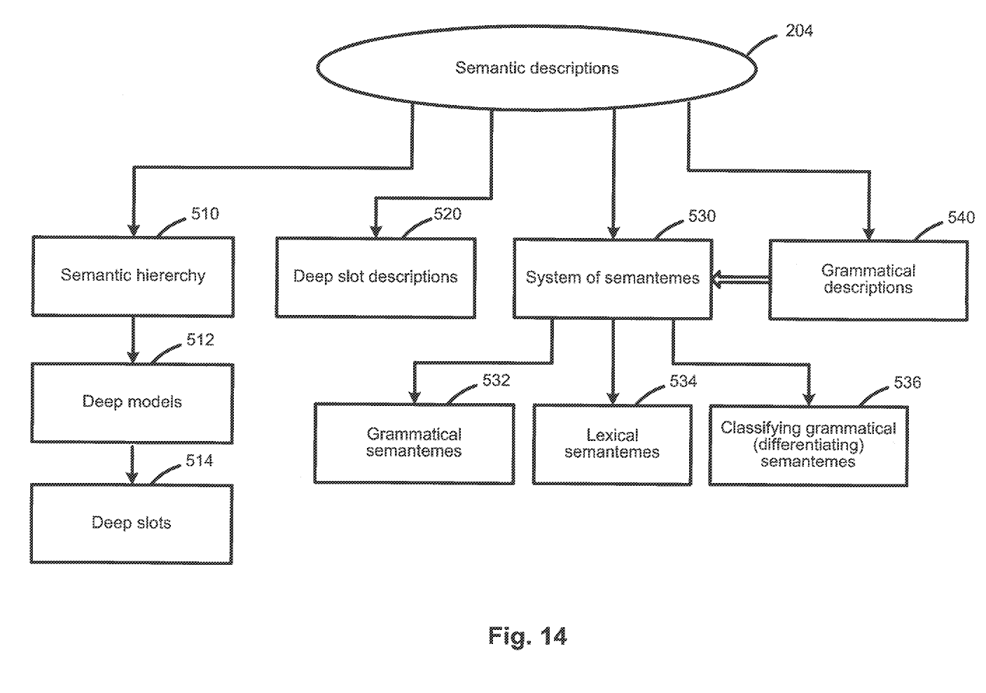

A constituent model may utilize a plurality of surface slots 415 of the child constituents and their linear order descriptions 416 to describe grammatical values 414 of possible fillers of these surface slots. Diatheses 417 may represent relationships between surface slots 415 and deep slots 514 (as shown in FIG. 14). Communicative descriptions 480 describe communicative order in a sentence.

Linear order description 416 may be represented by linear order expressions reflecting the sequence in which various surface slots 415 may appear in the sentence. The linear order expressions may include names of variables, names of surface slots, parenthesis, grammemes, ratings, the “or” operator, etc. In an illustrative example, a linear order description of a simple sentence of “Boys play football” may be represented as “Subject Core Object_Direct,” where Subject, Core, and Object_Direct are the names of surface slots 415 corresponding to the word order.

Communicative descriptions 480 may describe a word order in a syntform 412 from the point of view of communicative acts that are represented as communicative order expressions, which are similar to linear order expressions. The control and concord description 440 may comprise rules and restrictions which are associated with grammatical values of the related constituents and may be used in performing syntactic analysis.

Non-tree syntax descriptions 450 may be created to reflect various linguistic phenomena, such as ellipsis and coordination, and may be used in syntactic structures transformations which are generated at various stages of the analysis according to one or more aspects of the present disclosure. Non-tree syntax descriptions 450 may include ellipsis description 452, coordination description 454, as well as referential and structural control description 430, among others.

Analysis rules 460 may generally describe properties of a specific language and may be used in performing the semantic analysis. Analysis rules 460 may comprise rules of identifying semantemes 462 and normalization rules 464. Normalization rules 464 may be used for describing language-dependent transformations of semantic structures.

FIG. 14 illustrates exemplary semantic descriptions. Components of semantic descriptions 204 are language-independent and may include, but are not limited to, a semantic hierarchy 510, deep slots descriptions 520, a set of semantemes 530, and pragmatic descriptions 540.

The core of the semantic descriptions may be represented by semantic hierarchy 510 which may comprise semantic notions (semantic entities) which are also referred to as semantic classes. The latter may be arranged into hierarchical structure reflecting parent-child relationships. In general, a child semantic class may inherits one or more properties of its direct parent and other ancestor semantic classes. In an illustrative example, semantic class SUBSTANCE is a child of semantic class ENTITY and the parent of semantic classes GAS, LIQUID, METAL, WOOD_MATERIAL, etc.

Each semantic class in semantic hierarchy 510 may be associated with a corresponding deep model 512. Deep model 512 of a semantic class may comprise a plurality of deep slots 514 which may reflect semantic roles of child constituents in various sentences that include objects of the semantic class as the core of the parent constituent. Deep model 512 may further comprise possible semantic classes acting as fillers of the deep slots. Deep slots 514 may express semantic relationships, including, for example, “agent,” “addressee,” “instrument,” “quantity,” etc. A child semantic class may inherit and further expand the deep model of its direct parent semantic class.

Deep slots descriptions 520 reflect semantic roles of child constituents in deep models 512 and may be used to describe general properties of deep slots 514. Deep slots descriptions 520 may also comprise grammatical and semantic restrictions associated with the fillers of deep slots 514. Properties and restrictions associated with deep slots 514 and their possible fillers in various languages may be substantially similar and often identical. Thus, deep slots 514 are language-independent.

System of semantemes 530 may represents a plurality of semantic categories and semantemes which represent meanings of the semantic categories. In an illustrative example, a semantic category “DegreeOfComparison” may be used to describe the degree of comparison and may comprise the following semantemes: “Positive,” “ComparativeHigherDegree,” and “SuperlativeHighestDegree,” among others. In another illustrative example, a semantic category “RelationToReferencePoint” may be used to describe an order (spatial or temporal in a broad sense of the words being analyzed), such as before or after a reference point, and may comprise the semantemes “Previous” and “Subsequent.”. In yet another illustrative example, a semantic category “EvaluationObjective” can be used to describe an objective assessment, such as “Bad,” “Good,” etc.

System of semantemes 530 may include language-independent semantic attributes which may express not only semantic properties but also stylistic, pragmatic and communicative properties. Certain semantemes may be used to express an atomic meaning which corresponds to a regular grammatical and/or lexical expression in a natural language. By their intended purpose and usage, sets of semantemes may be categorized, e.g., as grammatical semantemes 532, lexical semantemes 534, and classifying grammatical (differentiating) semantemes 536.

Grammatical semantemes 532 may be used to describe grammatical properties of the constituents when transforming a syntactic tree into a semantic structure. Lexical semantemes 534 may describe specific properties of objects (e.g., “being flat” or “being liquid”) and may be used in deep slot descriptions 520 as restriction associated with the deep slot fillers (e.g., for the verbs “face (with)” and “flood,” respectively). Classifying grammatical (differentiating) semantemes 536 may express the differentiating properties of objects within a single semantic class. In an illustrative example, in the semantic class of HAIRDRESSER, the semanteme of <<RelatedToMen>> is associated with the lexical meaning of “barber,” to differentiate from other lexical meanings which also belong to this class, such as “hairdresser,” “hairstylist,” etc. Using these language-independent semantic properties that may be expressed by elements of semantic description, including semantic classes, deep slots, and semantemes, may be employed for extracting the semantic information, in accordance with one or more aspects of the present invention.

Pragmatic descriptions 540 allow associating a certain theme, style or genre to texts and objects of semantic hierarchy 510 (e.g., “Economic Policy,” “Foreign Policy,” “Justice,” “Legislation,” “Trade,” “Finance,” etc.). Pragmatic properties may also be expressed by semantemes. In an illustrative example, the pragmatic context may be taken into consideration during the semantic analysis phase.

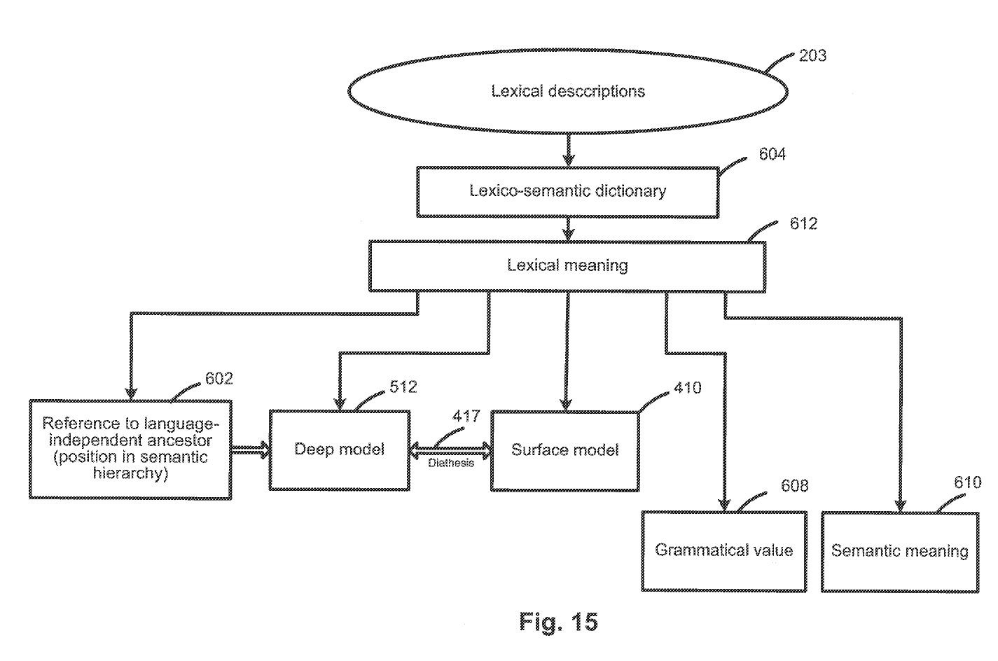

FIG. 15 illustrates exemplary lexical descriptions. Lexical descriptions 203 represent a plurality of lexical meanings 612, in a certain natural language , for each component of a sentence. For a lexical meaning 612, a relationship 602 to its language-independent semantic parent may be established to indicate the location of a given lexical meaning in semantic hierarchy 510.

A lexical meaning 612 of lexical-semantic hierarchy 510 may be associated with a surface model 410 which, in turn, may be associated, by one or more diatheses 417, with a corresponding deep model 512. A lexical meaning 612 may inherit the semantic class of its parent, and may further specify its deep model 152.

A surface model 410 of a lexical meaning may comprise includes one or more syntforms 412. A syntform, 412 of a surface model 410 may comprise one or more surface slots 415, including their respective linear order descriptions 416, one or more grammatical values 414 expressed as a set of grammatical categories (grammemes), one or more semantic restrictions associated with surface slot fillers, and one or more of the diatheses 417. Semantic restrictions associated with a certain surface slot filler may be represented by one or more semantic classes, whose objects can fill the surface slot.

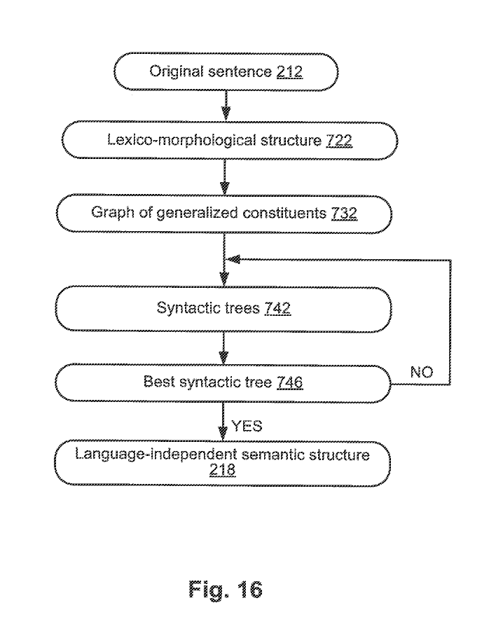

FIG. 16 schematically illustrates example data structures that may be employed by one or more methods described herein. Referring again to FIG. 9, at block 214, the computer system implementing the method may perform lexico-morphological analysis of sentence 212 to produce a lexico-morphological structure 722 of FIG. 16. Lexico-morphological structure 722 may comprise a plurality of mapping of a lexical meaning to a grammatical value for each lexical unit (e.g., word) of the original sentence. FIG. 10 schematically illustrates an example of a lexico-morphological structure.

At block 215, the computer system may perform a rough syntactic analysis of original sentence 212, in order to produce a graph of generalized constituents 732 of FIG. 16. Rough syntactic analysis involves applying one or more possible syntactic models of possible lexical meanings to each element of a plurality of elements of the lexico-morphological structure 722, in order to identify a plurality of potential syntactic relationships within original sentence 212, which are represented by graph of generalized constituents 732.

Graph of generalized constituents 732 may be represented by an acyclic graph comprising a plurality of nodes corresponding to the generalized constituents of original sentence 212, and further comprising a plurality of edges corresponding to the surface (syntactic) slots, which may express various types of relationship among the generalized lexical meanings. The method may apply a plurality of potentially viable syntactic models for each element of a plurality of elements of the lexico-morphological structure of original sentence 212 in order to produce a set of core constituents of original sentence 212. Then, the method may consider a plurality of viable syntactic models and syntactic structures of original sentence 212 in order to produce graph of generalized constituents 732 based on a set of constituents. Graph of generalized constituents 732 at the level of the surface model may reflect a plurality of viable relationships among the words of original sentence 212. As the number of viable syntactic structures may be relatively large, graph of generalized constituents 732 may generally comprise redundant information, including relatively large numbers of lexical meaning for certain nodes and/or surface slots for certain edges of the graph.

Graph of generalized constituents 732 may be initially built as a tree, starting with the terminal nodes (leaves) and moving towards the root, by adding child components to fill surface slots 415 of a plurality of parent constituents in order to reflect all lexical units of original sentence 212.

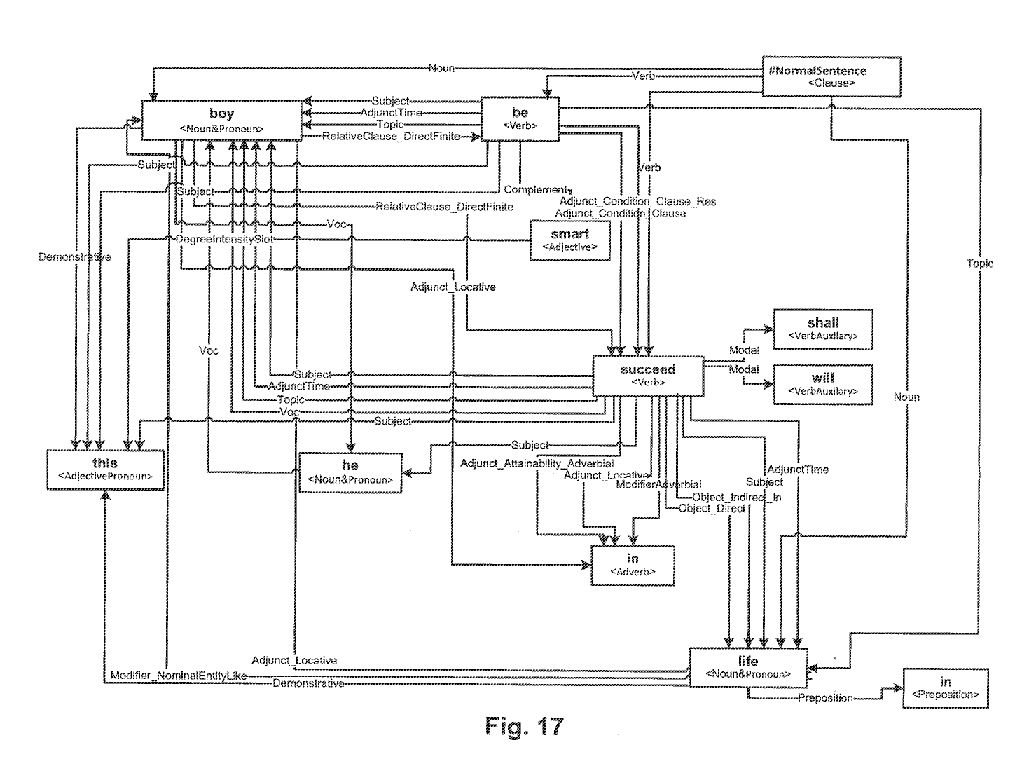

In certain implementations, the root of graph of generalized constituents 732 represents a predicate. In the course of the above described process, the tree may become a graph, as certain constituents of a lower level may be included into one or more constituents of an upper level. A plurality of constituents that represent certain elements of the lexico-morphological structure may then be generalized to produce generalized constituents. The constituents may be generalized based on their lexical meanings or grammatical values 414, e.g., based on part of speech designations and their relationships. FIG. 17 schematically illustrates an example graph of generalized constituents.

At block 216, the computer system may perform a precise syntactic analysis of sentence 212, to produce one or more syntactic trees 742 of FIG. 16 based on graph of generalized constituents 732. For each of one or more syntactic trees, the computer system may determine a general rating based on certain calculations and a priori estimates. The tree having the optimal rating may be selected for producing the best syntactic structure 746 of original sentence 212.

In the course of producing the syntactic structure 746 based on the selected syntactic tree, the computer system may establish one or more non-tree links (e.g., by producing redundant path among at least two nodes of the graph). If that process fails, the computer system may select a syntactic tree having a suboptimal rating closest to the optimal rating, and may attempt to establish one or more non-tree relationships within that tree. Finally, the precise syntactic analysis produces a syntactic structure 746 which represents the best syntactic structure corresponding to original sentence 212. In fact, selecting the best syntactic structure 746 also produces the best lexical values 240 of original sentence 212.

At block 217, the computer system may process the syntactic trees to the produce a semantic structure 218 corresponding to sentence 212. Semantic structure 218 may reflect, in language-independent terms, the semantics conveyed by original sentence. Semantic structure 218 may be represented by an acyclic graph (e.g., a tree complemented by at least one non-tree link, such as an edge producing a redundant path among at least two nodes of the graph). The original natural language words are represented by the nodes corresponding to language-independent semantic classes of semantic hierarchy 510. The edges of the graph represent deep (semantic) relationships between the nodes. Semantic structure 218 may be produced based on analysis rules 460, and may involve associating, one or more attributes (reflecting lexical, syntactic, and/or semantic properties of the words of original sentence 212) with each semantic class.

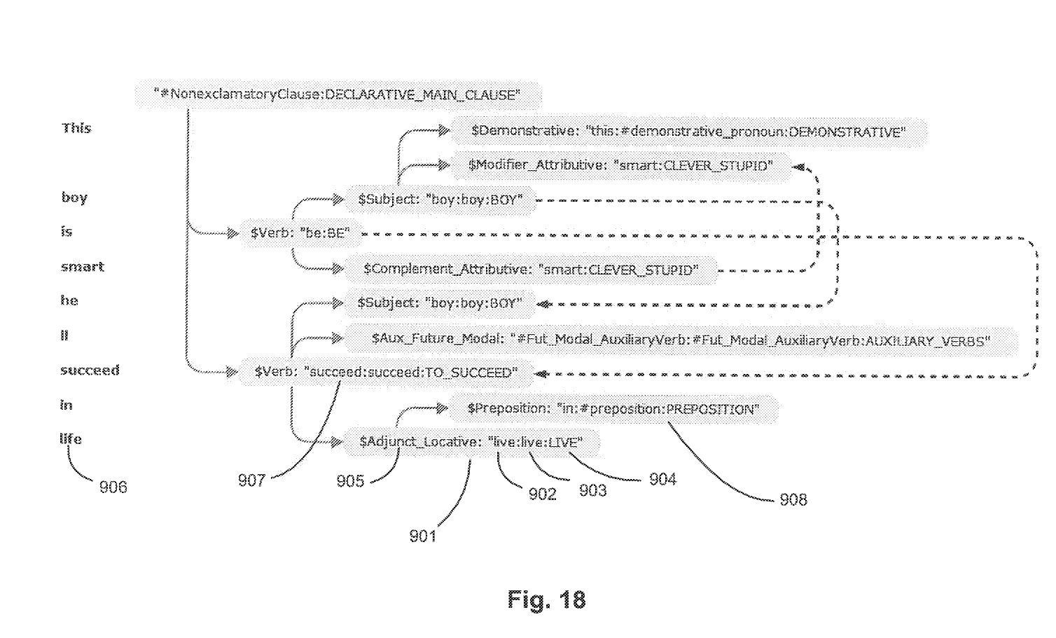

FIG. 18 illustrates an example syntactic structure of a sentence derived from the graph of generalized constituents illustrated by FIG. 17. Node 901 corresponds to the lexical element “life” 906 in original sentence 212. By applying the method of syntactico-semantic analysis described herein, the computer system may establish that lexical element “life” 906 represents one of the lexemes of a derivative form “live” 902 associated with a semantic class “LIVE” 904, and fills in a surface slot $Adjunctr_Locative (905) of the parent constituent, which is represented by a controlling node $Verb:succeed:succeed:TO_SUCCEED (907).

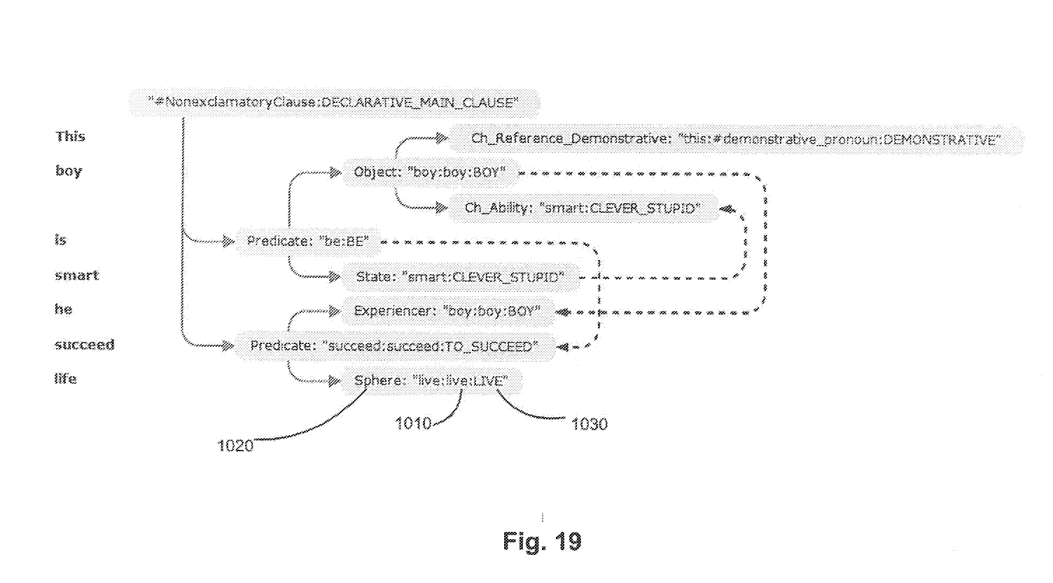

FIG. 19 illustrates a semantic structure corresponding to the syntactic structure of FIG. 18. With respect to the above referenced lexical element “life” 906 of FIG. 18, the semantic structure comprises lexical class 1010 and semantic classes 1030 similar to those of FIG. 18, but instead of surface slot 905, the semantic structure comprises a deep slot “Sphere” 1020.

As noted herein above, and ontology may be provided by a model representing objects pertaining to a certain branch of knowledge (subject area) and relationships among such objects. Thus, an ontology is different from a semantic hierarchy, despite the fact that it may be associated with elements of a semantic hierarchy by certain relationships (also referred to as “anchors”). An ontology may comprise definitions of a plurality of classes, such that each class corresponds to a concept of the subject area. Each class definition may comprise definitions of one or more objects associated with the class. Following the generally accepted terminology, an ontology class may also be referred to as concept, and an object belonging to a class may also be referred to as an instance of the concept.

In accordance with one or more aspects of the present disclosure, the computer system implementing the methods described herein may index one or more parameters yielded by the syntactico-semantic analysis. Thus, the methods described herein allow considering not only the plurality of words comprised by the original text corpus, but also pluralities of lexical meanings of those words, by storing and indexing all syntactic and semantic information produced in the course of syntactic and semantic analysis of each sentence of the original text corpus. Such information may further comprise the data produced in the course of intermediate stages of the analysis, the results of lexical selection, including the results produced in the course of resolving the ambiguities caused by homonymy and/or coinciding grammatical forms corresponding to different lexico-morphological meanings of certain words of the original language.

One or more indexes may be produced for each semantic structure. An index may be represented by a memory data structure, such as a table, comprising a plurality of entries. Each entry may represent a mapping of a certain semantic structure element (e.g., one or more words, a syntactic relationship, a morphological, lexical, syntactic or semantic property, or a syntactic or semantic structure) to one or more identifiers (or addresses) of occurrences of the semantic structure element within the original text.

In certain implementations, an index may comprise one or more values of morphological, syntactic, lexical, and/or semantic parameters. These values may be produced in the course of the two-stage semantic analysis, as described in more detail herein. The index may be employed in various natural language processing tasks, including the task of performing semantic search.

The computer system implementing the method may extract a wide spectrum of lexical, grammatical, syntactic, pragmatic, and/or semantic characteristics in the course of performing the syntactico-semantic analysis and producing semantic structures. In an illustrative example, the system may extract and store certain lexical information, associations of certain lexical units with semantic classes, information regarding grammatical forms and linear order, information regarding syntactic relationships and surface slots, information regarding the usage of certain forms, aspects, tonality (e.g., positive and negative), deep slots, non-tree links, semantemes, etc.

The computer system implementing the methods described herein may produce, by performing one or more text analysis methods described herein, and index any one or more parameters of the language descriptions, including lexical meanings, semantic classes, grammemes, semantemes, etc. Semantic class indexing may be employed in various natural language processing tasks, including semantic search, classification, clustering, text filtering, etc. Indexing lexical meanings (rather than indexing words) allows searching not only words and forms of words, but also lexical meanings, i.e., words having certain lexical meanings. The computer system implementing the methods described herein may also store and index the syntactic and semantic structures produced by one or more text analysis methods described herein, for employing those structures and/or indexes in semantic search, classification, clustering, and document filtering.

FIG. 20 illustrates a diagram of an example computer system 1000 which may execute a set of instructions for causing the computer system to perform any one or more of the methods discussed herein. The computer system may be connected to other computer system in a LAN, an intranet, an extranet, or the Internet. The computer system may operate in the capacity of a server or a client computer system in client-server network environment, or as a peer computer system in a peer-to-peer (or distributed) network environment. The computer system may be a provided by a personal computer (PC), a tablet PC, a set-top box (STB), a Personal Digital Assistant (PDA), a cellular telephone, or any computer system capable of executing a set of instructions (sequential or otherwise) that specify operations to be performed by that computer system. Further, while only a single computer system is illustrated, the term “computer system” shall also be taken to include any collection of computer systems that individually or jointly execute a set (or multiple sets) of instructions to perform any one or more of the methodologies discussed herein.

Exemplary computer system 1000 includes a processor 502, a main memory 504 (e.g., read-only memory (ROM) or dynamic random access memory (DRAM)), and a data storage device 518, which communicate with each other via a bus 530.

Processor 502 may be represented by one or more general-purpose computer systems such as a microprocessor, central processing unit, or the like. More particularly, processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 502 may also be one or more special-purpose computer systems such as an application specific integrated circuit (ASIC), a field programmable gate array (FPGA), a digital signal processor (DSP), network processor, or the like. Processor 502 is configured to execute instructions 526 for performing the operations and functions discussed herein.

Computer system 1000 may further include a network interface device 522, a video display unit 510, a character input device 512 (e.g., a keyboard), and a touch screen input device 514.

Data storage device 518 may include a computer-readable storage medium 524 on which is stored one or more sets of instructions 526 embodying any one or more of the methodologies or functions described herein. Instructions 526 may also reside, completely or at least partially, within main memory 504 and/or within processor 502 during execution thereof by computer system 1000, main memory 504 and processor 502 also constituting computer-readable storage media. Instructions 526 may further be transmitted or received over network 516 via network interface device 522.

In certain implementations, instructions 526 may include instructions of methods 100, 400 for reconstructing textual annotations associated with information objects, in accordance with one or more aspects of the present disclosure. While computer-readable storage medium 524 is shown in the example of FIG. 20 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining,” “computing,” “calculating,” “obtaining,” “identifying,” “modifying” or the like, refer to the actions and processes of a computer system, or similar electronic computer system, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
receiving, by a processor, a natural language text;
extracting, from the natural language text, a plurality of information objects, wherein each information object is associated with one or more attributes;
verifying values of the attributes of the plurality of information objects;
identifying an information object of the plurality of information objects, such that at least one attribute of the identified information object is not associated with at least one textual annotation; and
reconstructing a textual annotation associated with the attribute of the identified information object, wherein the textual annotation is represented by a fragment of the natural language text referencing a value of the attribute.

2. The method of claim 1, further comprising:
appending, to a training data set, a Resource Definition Framework (RDF) graph representing the natural language text with the reconstructed textual annotation; and
determining, based on the training data set, a value of a parameter of a classifier function utilized for performing a natural language processing operation.

3. The method of claim 2, wherein the RDF graph further comprises a ranking score associated with the reconstructed textual annotation.

4. The method of claim 1, wherein extracting the plurality of information objects further comprises:
performing syntactico-semantic analysis of the natural language text to produce a plurality of syntactico-semantic structures; and
evaluating one or more classifier functions using the plurality of syntactico-semantic structures.

5. The method of claim 1, further comprising:
determining confidence level values associated with the attributes of the plurality of information objects.

6. The method of claim 1, wherein verifying the attributes of the plurality of information objects further comprises:
accepting, via a graphical user interface, a user input modifying at least one attribute value.

7. The method of claim 1, wherein reconstructing the textual annotation associated with the attribute of the identified information object further comprises:
identifying one or more candidate textual annotations to be associated with the attribute, such that each candidate textual annotation is represented by a fragment of the natural language text referencing the value of the attribute;
determining ranking scores of the identified candidate textual annotations; and
selecting one or more candidate textual annotations having an optimal ranking score.

8. The method of claim 7, wherein each ranking score reflects a distance, in the natural language text, between a candidate textual annotation and a text token referencing the information object.

9. A method, comprising:
receiving, by a processor, a natural language text associated with a plurality of information objects, wherein each information object is associated with one or more attributes;
identifying an information object of the plurality of information objects, such that at least one attribute of the identified information object is not associated with at least one textual annotation;
identifying one or more candidate textual annotations to be associated with the attribute, such that each candidate textual annotation is represented by a fragment of the natural language text referencing the value of the attribute;
determining ranking scores of the identified candidate textual annotations; and
selecting one or more candidate textual annotations having an optimal ranking score.

10. The method of claim 9, wherein identifying one or more candidate textual annotations further comprises:
performing a fuzzy search of a value of the attribute in the natural language text.

11. The method of claim 9, wherein identifying one or more candidate textual annotations further comprises:
performing a search in the natural language text of a root morpheme of a value of the attribute.

12. The method of claim 9, wherein identifying one or more candidate textual annotations further comprises:
performing a search in the natural language text of a synonymic expression associated a value of the attribute.

13. The method of claim 9, wherein each ranking score reflects a distance, in the natural language text, between a candidate textual annotation and a text token referencing the information object.

14. The method of claim 9, wherein each ranking score reflects a presence, in the natural language text, of a second attribute within a pre-defined distance of a text token referencing the information object.

15. A computer-readable non-transitory storage medium comprising executable instructions that, when executed by a computer system, cause the computer system to:
receive a natural language text;
extract, from the natural language text, a plurality of information objects, wherein each information object is associated with one or more attributes;
verify values of the attributes of the plurality of information objects;
identify an information object of the plurality of information objects, such that at least one attribute of the identified information object is not associated with at least one textual annotation; and
reconstruct a textual annotation associated with the attribute of the identified information object, wherein the textual annotation is represented by a fragment of the natural language text referencing a value of the attribute.

16. The computer-readable non-transitory storage medium of claim 15, further comprising executable instructions causing the computer system to:
append, to a training data set, a Resource Definition Framework (RDF) graph representing the natural language text with the reconstructed textual annotation; and
determine, based on the training data set, a value of a parameter of a classifier function utilized for performing a natural language processing operation.

17. The computer-readable non-transitory storage medium of claim 15, wherein extracting the plurality of information objects further comprises:
performing syntactico-semantic analysis of the natural language text to produce a plurality of syntactico-semantic structures; and
evaluating one or more classifier functions using the plurality of syntactico-semantic structures.

18. The computer-readable non-transitory storage medium of claim 15, further comprising executable instructions causing the computer system to:
determine confidence level values associated with the attributes of the plurality of information objects.

19. The computer-readable non-transitory storage medium of claim 15, wherein verifying the attributes of the plurality of information objects further comprises:
accepting, via a graphical user interface, a user input modifying at least one attribute value.

20. The computer-readable non-transitory storage medium of claim 15, wherein reconstructing the textual annotation associated with the attribute of the identified information object further comprises:
identifying one or more candidate textual annotations to be associated with the attribute, such that each candidate textual annotation is represented by a fragment of the natural language text referencing the value of the attribute;
determining ranking scores of the identified candidate textual annotations; and
selecting one or more candidate textual annotations having an optimal ranking score.
